(19) United States
(12) Patent Application Publication
(10) Pub. No.: US 2015/0171711 A1
(43) Pub. Date: Jun. 18, 2015

(54) MOTOR HAVING ATTACHED CIRCUIT DEVICE

(71) Applicant: ASMO CO., LTD., Kosai-city (JP)

(72) Inventor: Hikaru OTSUKA, Kosai-city (JP)

(21) Appl. No.: 14/565,417

(22) Filed: Dec. 9, 2014

(30) Foreign Application Priority Data
Dec. 12, 2013 (JP) 2013-257086

(51) Int. Cl. H02K 11/00

(52) U.S. Cl. CPC H02K 11/0073

(57) ABSTRACT

A motor having an attached circuit device comprises an armature, that includes an armature core and a coil, and a circuit device, that includes a circuit board and a motor-side connector, and that controls current flowing within the coil. The motor-side connector comprises a terminal and a housing. The terminal includes a first connection portion to which a terminal of an external connector is connected and that is treated by plating, a second connection portion that is connected to the circuit board and that is treated by plating with a different material than the plating performed with respect to the first connection portion, and an intermediate portion that connects the first connection portion and the second connection portion together and that is integrally formed with the first connection portion and the second connection portion. The housing is formed using an insulting material so as to embed the intermediate portion therein.

### CROSS-REFERENCE TO RELATED APPLICATION

This application is claims priority under 35 USC 119 from Japanese Patent Application No. 2013-257086 filed on Dec. 12, 2013, the disclosure of which is incorporated by reference herein.

### BACKGROUND OF THE INVENTION

1. Technical Field

The present invention is related to a motor having an attached circuit device.

2. Related Art

A motor having an attached circuit device described in Japanese Patent Application Laid-Open (JP-A) No. 2001-69740 includes a circuit device that controls current flowing in winding wire configuring a portion of a starter motor. The circuit device includes a circuit board, and plural circuit elements and power connectors attached to the circuit board.

Additionally, plating treatment such as tin plating is performed with respect to locations where terminals of power connectors are bonded to the circuit board (terminal rear end portions) and to portions where terminals of external connectors are connected (terminal leading end portions), in order to suppress the formation of an oxidized film at these locations (see JP-A No. 2004-111058).

### SUMMARY

However, the connectors described in JP-A No. 2004-111058 have connector terminals formed by joining the terminal rear end portions to the terminal leading end portions, and hence the number of components to manage is increased. There is also an increase in manufacturing process accompanying the increase in components.

In consideration of the above circumstances, an object of the invention is to obtain a motor having an attached circuit device capable of suppressing an increase in the number of components to manage and suppressing an increase in the manufacturing process.

### SOLUTION TO PROBLEM

A motor having an attached circuit device of a first aspect of the present invention includes an armature that includes an armature core and a coil formed by winding conductive wire around a specific location at the armature core, and a circuit device that includes a circuit board to which a terminal end portion of the wire is connected and a motor-side connector, and that controls current flowing within the coil. The motor-side connector includes a terminal and a housing. The terminal includes a first connection portion to which a terminal of an external connector is connected and that is treated by plating, a second connection portion that is connected to the circuit board and that is treated by plating with a different material than the plating performed with respect to the first connection portion, and an intermediate portion that connects the first connection portion and the second connection portion together and that is integrally formed with the first connection portion and the second connection portion. The housing is formed using an insulting material so as to embed the intermediate portion therein.

The motor having an attached circuit device of the first aspect controls the current flowing in the coil when the external connector is connected to the motor-side connector and supplies power to the circuit device. A rotating magnetic field is thereby generated in the armature core, rotating the motor having an attached circuit device. In the present exemplary embodiment, the terminal is integrally formed with the first connection portion, the second connection portion, and the intermediate portion. Plating is performed with respect to the first connection portion and the second connection portion, and motor-side connector may be configured by embedding the intermediate portion of the terminal in the housing. This thereby enables an increase in the number of components to be suppressed compared to cases in which the first connection portion and the second connection portion are formed as separate bodies, namely compared to cases in which the terminal has a divided structure, and hence also enables an increase in the number of components of the motor having an attached circuit device to be suppressed. Moreover, by adopting the structure in which the intermediate portion of the terminal is embedded in the housing, contact through moisture between the plating of the first connection portion and the plating of the second connection portion, namely contact through moisture between portions plated with mutually different materials can be suppressed.

### BRIEF DESCRIPTION OF THE DRAWINGS

Exemplary embodiments of the present invention will be described in detail based on the following figures, wherein:

FIG. 1 is a side cross-section illustrating a cross-section of a motor having an attached circuit device sectioned along the axial direction of a rotation shaft;

FIG. 2 is a perspective view illustrating a motor-side connector;

FIG. 3A is a face-on view of a motor-side connector;

FIG. 3B is a side view of a motor-side connector;

FIG. 3C is a rear view of a motor-side connector; and

FIG. 3D is a plan view of a motor-side connector.

### DETAILED DESCRIPTION OF THE INVENTION

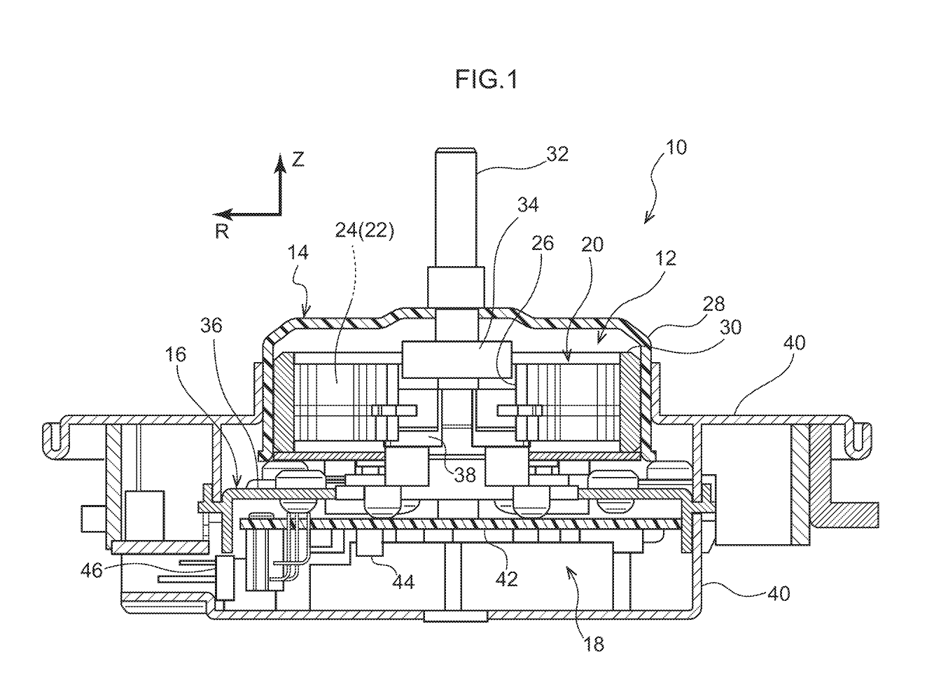

Explanation follows regarding a motor having an attached circuit device according to an exemplary embodiment of the present invention, with reference to FIG. 1 to FIG. 3D. In the drawings, as appropriate, the arrow Z direction and the arrow R direction illustrate an axial direction and a radial direction of the motor having an attached circuit device, respectively. In the following, unless stated otherwise, references simply to axial direction, radial direction, and circumferential direction refer to the axial direction radial direction, and circumferential direction of the motor having an attached circuit device.

As illustrated in FIG. 1, a brushless motor 10 serving as a motor having an attached circuit device of the present exemplary embodiment is employed as a fan motor that rotates a fan to cool a radiator, or a blower motor configuring part of a vehicle air conditioner. The brushless motor 10 includes a stator 12 serving as an armature to generate a circulating magnetic field, and a rotor 14 that is imparted with the circulating magnetic field of the stator 12 and rotates. The brushless motor 10 also includes a base 16 to which the stator 12 and the like are fixed, and a circuit device 18 that controls conduction to coils 24 (winding wire 22) configuring part of the stator 12.

The stator 12 is configured including principal elements of a stator core 20 serving as a stator core formed using a magnetic material, such as steel, and the coils 24 formed by winding a conductive wire 22 onto specific locations of the stator core 20. More specifically, the stator core 20 includes a yoke section 26 formed in a substantially cylindrical shape, and plural teeth portions that extend out from an outside end portion in a radial direction of the yoke section 26 toward outside in the radial direction. The coils 24 are formed around each of the teeth portions by winding the wire 22 around the teeth portions.

The rotor 14 includes a lidded cylindrical shaped rotor housing 28, and plural rotor magnets 30 fixed to an inner peripheral face of the rotor housing 28. The plural rotor magnets 30 are disposed facing the stator 12 along the radial direction. A rotation shaft 32 is fixed to an axial center portion of the rotor housing 28, and the rotation shaft 32 is supported by a base 16 through a bearing 34.

The base 16 is formed using an aluminum alloy or the like, and the base 16 includes a base wall section 36 having a thickness direction along the axial direction and extending out in the radial direction. A stator fixing portion 38 that fixes the stator 12 is provided at a substantially central portion of the base 16. The stator 12 is configured so as to be fixed to the base 16 by press-fitting the yoke section 26 of the stator core 20 onto the stator fixing portion 38.

The circuit device 18 is disposed inside a case 40 formed in a box shape. The circuit device 18 is configured with principal elements of a circuit board 42, plural circuit elements 44, and a motor-side connector 46 attached to the circuit board 42. The circuit board 42 is formed in a rectangular shape with its thickness direction along the axial direction, and with a specific conductive pattern section formed on the circuit board 42. The coils 24 of the stator 12 can be made to conduct through the pattern section. The terminal rear end portions of the wire 22 forming the coils 24 is connected to the circuit board 42 through a buzz bar or the like, not illustrated in the drawings.

Explanation next follows regarding a configuration of the motor-side connector 46 that is a principal section of the present exemplary embodiment.

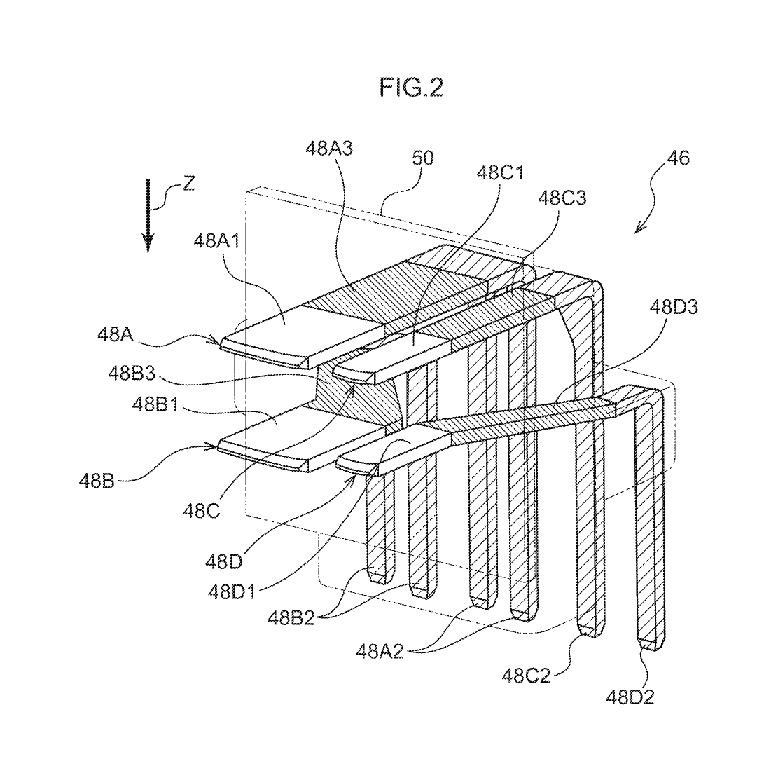

As illustrated in FIG. 2, the motor-side connector 46 includes, as terminals, an A terminal 48A, a B terminal 48B, a C terminal 48C, and a D terminal 48D, and is configured so as to be supported by a housing 50 formed using an insulating material such as a resin.

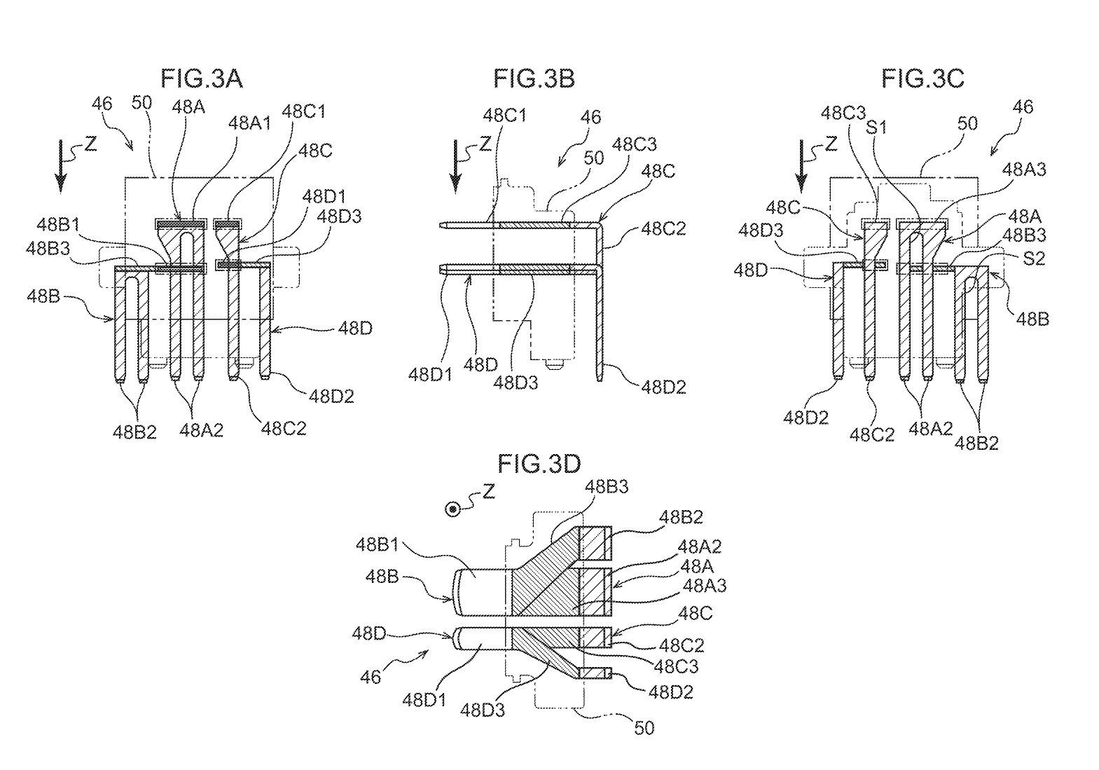

As illustrated in FIG. 3A to FIG. 3D, the A terminal 48A is formed in a substantially L-shape when viewed from the side, such as by pressing a sheet aluminum or sheet copper member. The A terminal 48A includes a first connection portion 48A1 to which an external connector, not illustrated in the drawings, is connected, a second connection portion 48A2 that is connected to the circuit board 42, and an intermediate portion 48A3 that is embedded in the housing 50. The first connection portion 48A1 is formed in a rectangular shape with its thickness direction along the same direction as the thickness direction of the circuit board 42 (the axial direction). The second connection portion 48A2 is formed in a rectangular shape with its thickness direction along the extension direction of the circuit board 42. A slit S1 is formed along the length direction of the second connection portion 48A2, with the second connection portion 48A2 bifurcated into two prongs by the slit S1. The intermediate portion 48A3 extends in the same direction as the extension direction of the first connection portion 48A1, and the intermediate portion 48A3 connects the first connection portion 48A1 and the second connection portion 48A2 together. Undercoat plating of the first connection portion 48A1, the second connection portion 48A2, and the intermediate portion 48A3 is performed. Silver plating using the precious metal silver is then performed with respect to the first connection portion 48A1, and tin plating using the base metal tin is performed with respect to the second connection portion 48A2. This thereby configures the A terminal 48A. In the present exemplary embodiment, silver plating is also performed with respect to a portion of the end of the intermediate portion 48A3 on the first connection portion 48A1 side, and tin plating is also performed with respect to a portion of the end of the intermediate portion 48A3 on the second connection portion 48A2 side.

The B terminal 48B is also formed in a substantially L-shape when viewed from the side, such as by pressing a sheet aluminum or sheet copper member, similarly to in the A terminal 48A. The B terminal 48B includes a first connection portion 48B1 to which an external connector, not illustrated in the drawings, is connected and that is disposed alongside the first connection portion 48A1 of the A terminal 48A in the thickness direction, a second connection portion 48B2 that is connected to the circuit board 42, and an intermediate portion 48B3 that is embedded in the housing 50. A slit S2 is formed along the length direction of the second connection portion 48B2, with the second connection portion 48B2 bifurcated into two prongs by the slit S2. The intermediate portion 48B3 extends parallel to the intermediate portion 48A3 of the A terminal 48A, and the intermediate portion 48B3 connects the first connection portion 48B1 and the second connection portion 48B2 together. The end portion of the intermediate portion 48B3 on the second connection portion 48B2 side is offset with respect to the end portion of the intermediate portion 48A3 of the A terminal 48A on the second connection portion 48A2 side. Silver plating and tin plating are performed with respect to the first connection portion 48B1 and the second connection portion 48B2, respectively, similarly to in the A terminal 48A, thereby configuring the B terminal 48B.

The C terminal 48C is also formed in a substantially L-shape when viewed from the side, such as by pressing a sheet aluminum or sheet copper member, similarly to in the A terminal 48A and the B terminal 48B. The C terminal 48C includes a first connection portion 48C 1 to which an external connector, not illustrated in the drawings, is connected and that is disposed alongside the first connection portion 48A1 of the A terminal 48A in a direction orthogonal to the thickness direction thereof, a second connection portion 48C2 that is connected to the circuit board 42, and an intermediate portion 48C3 that is embedded in the housing 50. The intermediate portion 48C3 connects the first connection portion 48C1 and the second connection portion 48C2 together. Silver plating and tin plating are the first connection portion 48C1 and the second connection portion 48C2, respectively, similarly to in the A terminal 48A and the B terminal 48B, thereby configuring the C terminal 48C.

The D terminal 48D is also formed in a substantially L-shape when viewed from the side, such as by pressing a sheet aluminum or sheet copper member, similarly to in the A terminal 48A etc. The D terminal 48D includes a first connection portion 48D1 to which an external connector, not illustrated in the drawings, is connected and that is disposed alongside the first connection portion 48A1 of the A terminal 48A in the thickness direction thereof, a second connection portion 48D2 that is connected to the circuit board 42, and an intermediate portion 48D3 that is embedded in the housing 50. The intermediate portion 48D3 extends parallel to the intermediate portion 48C3 of the C terminal 48C, and the intermediate portion 48D3 connects the first connection portion 48D1 and the second connection portion 48D2 together. The end portion of the intermediate portion 48D3 on the second connection portion 48D2 side is offset with respect to the end portion of the intermediate portion 48C3 of the C terminal 48C on the second connection portion 48C2 side. Silver plating and tin plating are performed with respect to the first connection portion 48D1 and the second connection portion 48D2, respectively, similarly to in the A terminal 48A etc., thereby configuring the D terminal 48D.

As explained above, the intermediate portions 48A3, 48B3, 48C3, 48D3 of the A terminal 48A, the B terminal 48B, the C terminal 48C and the D terminal 48D are embedded in the housing 50. The motor-side connector 46 is thereby configured with the A terminal 48A, the B terminal 48B, the C terminal 48C, and the D terminal 48D supported by the housing 50. In the present exemplary embodiment, all of the portions of the A terminal 48A, the B terminal 48B, the C terminal 48C, and the D terminal 48D not subjected to silver plating or tin plating are embedded in the housing 50.

As illustrated in FIG. 1, the motor-side connector 46 is attached to the circuit board 42, such as by soldering the second connection portions 48A2, 48B2, 48C2, 48D2 of the A terminal 48A, the B terminal 48B, the C terminal 48C and the D terminal 48D.

Operation and Advantageous Effects of the Present Exemplary Embodiment Explanation next follows regarding the operation and advantageous effects of the present exemplary embodiment.

As illustrated in FIG. 1, according to the brushless motor 10 of the present exemplary embodiment, the current flowing in the coils 24 is controlled when power is supplied by an external connector, not illustrated in the drawings, to the circuit device 18 connected to the motor-side connector 46. A rotating magnetic field is thereby generated in the stator core 20, and the rotor 14 rotates together with the rotation shaft 32.

As illustrated in FIG. 2 through FIG. 3D, in the present exemplary embodiment, the A terminal 48A is an integrated structure including the first connection portion 48A1, the second connection portion 48A2, and the intermediate portion 48A3, and the B terminal 48B, the C terminal 48C, and the D terminal 48D have each have similar integrated structures to that of the A terminal 48A. An increase in the number of components of the motor-side connector 46 can accordingly be suppressed compared to cases in which the A terminal 48A, the B terminal 48B, the C terminal 48C and the D terminal 48D have divided structures, thereby enabling an increase in the number of components of the brushless motor 10 to be suppressed.

Due to adopting the structure in which the intermediate portions 48A3, 48B3, 48C3, 48D3 of the A terminal 48A, the B terminal 48B, the C terminal 48C, and the D terminal 48D are embedded in the housing 50, this enables contact through moisture to be suppressed between the silver plated first connection portions 48A1, 48B1, 48C1, 48D1 and the tin plated second connection portions 48A2, 48B2, 48C2, 48D2, namely contact through moisture to be suppressed between sites plated with a different material.

In the present exemplary embodiment, the first connection portions 48A1, 48B1, 48C1, 48D1 of the A terminal 48A, the B terminal 48B, the C terminal 48C and the D terminal 48D are silver plated, and the second connection portions 48A2, 48B2, 48C2, 48D2 thereof are tin plated. Namely, a material (plating material) having a lower resistance to electricity than that of the plating on the second connection portions 48A2, 48B2, 48C2, 48D2 is employed for plating treatment of the first connection portions 48A1, 48B1, 48C1, 48D1. This thereby enables the contact resistance at the interface between the first connection portions 48A1, 48B1, 48C1, 48D1 and the external connector to be reduced compared to cases in which the first connection portions 48A1, 48B1, 48C1, 48D1 are treated with the same plating treatment as that of the second connection portions 48A2, 48B2, 48C2, 48D2.

Moreover, in the present exemplary embodiment, there are portions present at the intermediate portions 48A3, 48B3, 48C3, 48D3 of the A terminal 48A, the B terminal 48B, the C terminal 48C, and the D terminal 48D where neither silver plating nor tin plating has been performed. This thereby enables corrosion of the terminals (the A terminal 48A, the B terminal 48B, the C terminal 48C, and the D terminal 48D) due to contact between silver plating and tin plating to be prevented.

In the present exemplary embodiment, it is possible to easily perform soldering of the second connection portions 48A2, 48B2, 48C2, 48D2 to the circuit board 42 due to performing the tin plating to the second connection portions 48A2, 48B2, 48C2, 48D2 of the A terminal 48A, the B terminal 48B, the C terminal 48C, and the D terminal 48D, namely it is easy to attach the motor-side connector 46 to the circuit board.

Moreover, in the present exemplary embodiment, due to adopting the structure in which all the portions of the A terminal 48A, the B terminal 48B, the C terminal 48C, and the D terminal 48D that have not been silver plated or tin plated are buried in the housing 50, corrosion of portions not silver plated or tin plated due to moisture in the air adhering thereto can be suppressed.

In the present exemplary embodiment, explanation has been given of an example of a structure in which all the portions of the A terminal 48A, the B terminal 48B, the C terminal 48C, and the D terminal 48D that have not been silver plated or tin plated are buried in the housing 50, however the present invention is not limited thereto. Whether or not all of the portions of the A terminal 48A, the B terminal 48B, the C terminal 48C, and the D terminal 48D that have not been silver plated or tin plated are buried in the housing 50 may be appropriately set, such as in consideration of the usage environment of the brushless motor 10.

In the present exemplary embodiment, explanation has been given of an example in which silver plating is performed with respect to the first connection portions 48A1, 48B1, 48C1, 48D1 of the A terminal 48A, the B terminal 48B, the C terminal 48C, and the D terminal 48D, and tin plating is performed with respect to the second connection portions 48A2, 48B2, 48C2, 48D2, however the present invention is not limited thereto. The type of plating may be appropriately set in according to considerations such as of the usage environment of the brushless motor 10, and the materials of the A terminal 48A, the B terminal 48B, the C terminal 48C, and the D terminal 48D.

An exemplary embodiment of the present invention has been explained above, however the present invention is not limited thereto, and obviously it is possible to implement various modifications other than described above within a range not departing from the spirit of the invention.

Explanation follows again regarding various aspects of the present invention.

A motor having an attached circuit device of a first aspect of the present invention includes an armature that includes an armature core and a coil formed by winding conductive wire around a specific location at the armature core, and a circuit device that includes a circuit board to which a terminal end portion of the wire is connected and a motor-side connector, and that controls current flowing within the coil. The motor-side connector includes a terminal and a housing. The terminal includes a first connection portion to which a terminal of an external connector is connected and that is treated by plating, a second connection portion that is connected to the circuit board and that is treated by plating with a different material than the plating performed with respect to the first connection portion, and an intermediate portion that connects the first connection portion and the second connection portion together and that is integrally formed with the first connection portion and the second connection portion. The housing is formed using an insulting material so as to embed the intermediate portion therein.

A motor having an attached circuit device of a second aspect of the present invention is the motor having an attached circuit device of the first aspect, wherein the plating of the first connection portion of the terminal is performed with a material having a lower electrical resistance than the material used to plate the second connection portion.

The motor having an attached circuit device of the second aspect enables the contact resistance at the interface between the first connection portion and the external connector to be reduced compared to cases in which the same plating is performed with respect to the first connection portion to that of the second connection portion.

A motor having an attached circuit device of a third aspect of the present invention is the motor having an attached circuit device of the first aspect or the second aspect, wherein at least a portion of the intermediate portion is not treated with either material used to plate the first connection portion or the second connection portion.

The motor having an attached circuit device of the third aspect enables corrosion of the terminal due to contact between the plating of the first connection portion and the plating of the second connection portion to be prevented.

A motor having an attached circuit device of a fourth aspect of the present invention is the motor having an attached circuit device of any one of the first aspect to the third aspect, wherein the second connection portion of the terminal and the circuit board are joined by soldering, and plating of the second connection portion is performed using a base metal material.

The motor having an attached circuit device of the fourth aspect enables easy soldering of the second connection portion to the circuit board, namely, enables easy attachment of the motor-side connector to the circuit board.

The motor having an attached circuit device of the fifth aspect of the present invention is the motor having an attached circuit device of any one of the first aspect to the fourth aspect, wherein all portions of the terminal, which are not treated during the plating of the first connection portion and the second connection portion, are embedded in the housing.

The motor having an attached circuit device of the fifth aspect enables corrosion of portions of the terminal, which are not treated during the plating of the first connection portion and the second connection portion, due to air and adhering moisture, to be suppressed.

What is claimed is:

1. A motor having an attached circuit device comprising an armature that includes an armature core and a coil formed by winding conductive wire around a specific location at the armature core, and a circuit device that includes a circuit board to which a terminal end portion of the wire is connected and a motor-side connector, and that controls current flowing within the coil, wherein:
the motor-side connector comprises a terminal and a housing;
the terminal includes a first connection portion to which a terminal of an external connector is connected and that is treated by plating, a second connection portion that is connected to the circuit board and that is treated by plating with a different material than the plating performed with respect to the first connection portion, and an intermediate portion that connects the first connection portion and the second connection portion together and that is integrally formed with the first connection portion and the second connection portion; and
the housing is formed using an insulting material so as to embed the intermediate portion therein.

2. The motor having an attached circuit device of claim 1, wherein the plating of the first connection portion of the terminal is performed with a material having a lower electrical resistance than the material used to plate the second connection portion.

3. The motor having an attached circuit device of claim 1, wherein at least a portion of the intermediate portion is not treated with either material used to plate the first connection portion or the second connection portion.

4. The motor having an attached circuit device of claim 2, wherein at least a portion of the intermediate portion is not treated with either material used to plate the first connection portion or the second connection portion.

5. The motor having an attached circuit device of claim 1, wherein:
the second connection portion of the terminal and the circuit board are joined by soldering; and
the plating of the second connection portion is performed using a base metal material.

6. The motor having an attached circuit device of claim 2, wherein:
the second connection portion of the terminal and the circuit board are joined by soldering; and
the plating of the second connection portion is performed using a base metal material.

7. The motor having an attached circuit device of claim 3, wherein:
the second connection portion of the terminal and the circuit board are joined by soldering; and
the plating of the second connection portion is performed using a base metal material.

8. The motor having an attached circuit device of claim 1, wherein all portions of the terminal, which are not treated during the plating of the first connection portion and the second connection portion, are embedded in the housing.

9. The motor having an attached circuit device of claim 2, wherein
all portions of the terminal, which are not treated during the plating of the first connection portion and the second connection portion, are embedded in the housing.

10. The motor having an attached circuit device of claim 3, wherein
all portions of the terminal, which are not treated during the plating of the first connection portion and the second connection portion, are embedded in the housing.

11. The motor having an attached circuit device of claim 4, wherein
all portions of the terminal, which are not treated during the plating of the first connection portion and the second connection portion, are embedded in the housing.
